(19) United States
(12) Patent Application Publication
(10) Pub. No.: US 2010/0006010 A1
(43) Pub. Date: Jan. 14, 2010

(54) MATRIX FOR MASONRY ELEMENTS AND METHOD OF MANUFACTURE THEREOF

(76) Inventor: Ihor Hinczak, New South Wales (AU)

Correspondence Address: GREENBLUM & BERNSTEIN, P.L.C., 1950 ROLAND CLARKE PLACE, RESTON, VA, 20191, US

(21) Appl. No.: 12/281,253

(22) PCT Filed: Mar. 1, 2007
(86) PCT No.: PCT/AU2007/000232

§ 371 Date: Apr. 28, 2009

(30) Foreign Application Priority Data
Mar. 1, 2006 (AU) 2006901033

(51) Int. Cl. C04B 14/00

(52) U.S. Cl. 106/707

(57) ABSTRACT

A cementitious matrix for forming a moulded masonry product, the matrix formed from a group of materials comprising; an aggregate comprising granulated iron blast furnace slag; air-cooled iron blast furnace slag, bottom ash, pulverised fuel ash and at least one cementitious binder; and ground granulated iron blast furnace slag acting as binder and aggregate; and water.

### BACKGROUND

The present invention relates to brick and masonry elements and more particularly relates to brick and masonry products manufactured from a cementitious matrix including lightweight aggregate materials.

The invention further relates to methods of manufacture of masonry elements for use in but not limited to structures and to a matrix for manufacture of such masonry elements. More particularly the invention relates to a matrix for manufacture of masonry elements which includes blast furnace slag as an aggregate. The invention further relates to products which are manufactured from such matrix and include granulated iron blast furnace slag and a hydraulic cement.

### PRIOR ART

The use of granulated iron blast furnace slag in the construction industry is well established. However, the use has been mainly as a supplementary cementitious material when ground to a very fine powder. Some granulated iron blast furnace slag has been used for partial replacement of normal construction aggregates for improvement of chemical durability and fire resistance.

The prior art is replete with disclosures of a wide variety of cement and concrete matrices each designed to fulfil a particular purpose.

Portland cement, the basic ingredient of known concrete mixes, is a chemical combination of calcium, silicon, aluminum, iron and small amounts of other ingredients to which gypsum is added in the final grinding process to regulate the setting time of the concrete. Lime and silica make up about 85% of the mass. Common among the materials used in its manufacture are limestone, shells, and chalk or marl combined with shale, clay, slate or blast furnace slag, silica sand, and iron ore.

Each step in manufacture of portland cement is checked by frequent chemical and physical tests in plant laboratories. The finished product is also analyzed and tested to ensure that it complies with all specifications.

Two different processes, “dry” and “wet,” are used in the manufacture of portland cement.

When rock is the principal raw material, the first step after quarrying in both processes is the primary crushing. Rock is fed through crushers reducing the rock to a maximum size of about 150 mm. The rock then goes to secondary crushers or hammer mills for reduction to about 75 mm smaller. ). In the dry process, raw materials are ground, mixed, and fed to the kiln in a dry state.

In the wet process, the raw materials, properly proportioned, are then ground with water, thoroughly mixed and fed into a kiln in the form of a “slurry” containing enough water to make it fluid In other respects, the two processes are essentially alike.

The raw material is heated to about 2,700 degrees F. in cylindrical steel rotary kilns lined with special firebrick. Kilns are mounted with the axis inclined slightly from the horizontal. The finely ground raw material or the slurry is fed into the higher end. At the lower end is a roaring blast of flame, produced by precisely controlled burning of powdered coal, oil or gas under forced draft. As the material moves through the kiln, certain elements are driven off in the form of gases. The remaining elements unite to form a new substance with new physical and chemical characteristics. The new substance, called clinker, is formed in pieces about the size of marbles. Clinker is discharged red-hot from the lower end of the kiln and generally is brought down to handling temperature in various types of coolers.

One of the most common concrete mixes contains 11% ordinary Portland cement which typically contains 6% air, up to 60-70% aggregate which may be for instance gravel or crushed stone; and 16% water.

Aggregates are inert granular materials such as sand, gravel, or crushed stone that, along with water and portland cement, are an essential ingredient in concrete. For a good concrete mix, aggregates need to be clean, hard, strong particles free of absorbed chemicals or coatings of clay and other fine materials that could cause the deterioration of concrete. Aggregates, which account for 60 to 75 percent of the total volume of concrete, are divided into two distinct categories-fine and coarse. Fine aggregates generally consist of natural sand or crushed stone with most particles passing through a 9.5-mm sieve. Coarse aggregates are any particles greater than 4.75 mm, but generally range between 9.5 mm to 37.5 mm in diameter. Gravels constitute the majority of coarse aggregate used in concrete with crushed stone making up most of the remainder.

Natural gravel and sand are usually dug or dredged from a pit, river, lake, or seabed. Crushed aggregate is produced by crushing quarry rock, boulders, cobbles, or large-size gravel. Recycled concrete is a viable source of aggregate and has been satisfactorily used in granular sub bases, soil-cement, and in new concrete. Aggregate processing consists of crushing, screening, and washing the aggregate to obtain proper cleanliness and gradation. If necessary, a benefaction process such as jigging or heavy media separation can be used to upgrade the quality. Aggregates strongly influence concrete's freshly mixed and hardened properties, mixture proportions, and economy. Consequently, selection of aggregates is an important process. Although some variation in aggregate properties is expected, characteristics that are considered when selecting aggregate include:
grading
durability
particle shape and surface texture
abrasion and skid resistance
unit weights and voids
absorption and surface moisture

Grading refers to the determination of the particle- size distribution for aggregate. Grading limits and maximum aggregate size are specified because grading and size affect the amount of aggregate used as well as cement and water requirements, workability, pumpability, and durability of concrete. In general, if the water-cement ratio is chosen correctly, a wide range in grading can be used without a major effect on strength. Close control of mix proportions is necessary to avoid segregation.

Particle shape and surface texture influence the properties of freshly mixed concrete more than the properties of hardened concrete. Rough-textured, angular, and elongated particles require more water to produce workable concrete than smooth, rounded compact aggregate. Consequently, the cement content must also be increased to maintain the water-cement ratio. Generally, flat and elongated particles are avoided or are limited to about 15 percent by weight of the total aggregate. Unit-weight measures the volume that graded aggregate and the voids between them will occupy in concrete. The void content between particles affects the amount of cement paste required for the mix. Angular aggregates increase the void content. Larger sizes of well-graded aggregate and improved grading decrease the void content. Absorption and surface moisture of aggregate are measured when selecting aggregate because the internal structure of aggregate is made up of solid material and voids that may or may not contain water. The amount of water in the concrete mixture must be adjusted to include the moisture conditions of the aggregate. Abrasion and skid resistance of an aggregate are essential when the aggregate is to be used in concrete constantly subject to abrasion as in heavy-duty floors or pavements. Harder aggregate can be selected in highly abrasive conditions to minimize wear. Chemical admixtures are the ingredients in concrete other than portland cement, water, and aggregate that are added to the mix immediately before or during mixing. Producers use admixtures primarily to reduce the cost of concrete construction; to modify the properties of hardened concrete; to ensure the quality of concrete during mixing, transporting, placing, and curing; and to overcome certain emergencies during concrete operations.

Successful use of admixtures depends on the use of appropriate methods of batching and concreting. Most admixtures are supplied in ready-to-use liquid form and are added to the concrete at the plant or at the jobsite. Certain admixtures, such as pigments, expansive agents, and pumping aids are usually used only in relatively small amounts and are usually batched by hand from premeasured containers.

The effectiveness of an admixture depends on several factors including: type and amount of cement, water content, mixing time, slump, and temperatures of the concrete and air. Sometimes, effects similar to those achieved through the addition of admixtures can be achieved by altering the concrete mixture-reducing the water-cement ratio, adding additional cement, using a different type of cement, or changing the aggregate and aggregate gradation.

Admixtures are classed according to function. There are five distinct classes of chemical admixtures: air-entraining, water-reducing, retarding, accelerating, and plasticizers (superplasticizers). All other varieties of admixtures fall into the specialty category whose functions include corrosion inhibition, shrinkage reduction, alkali-silica reactivity reduction, workability enhancement, bonding, damp proofing, and colouring. Air-entraining admixtures, which are used to purposely place microscopic air bubbles into the concrete, are discussed more fully in “Air-Entrained Concrete.”

Water-reducing admixtures usually reduce the required water content for a concrete mixture by about 5 to 10 percent. Consequently, concrete containing a water-reducing admixture needs less water to reach a required slump than untreated concrete. The treated concrete can have a lower water-cement ratio. This usually indicates that a higher strength concrete can be produced without increasing the amount of cement. Recent advancements in admixture technology have led to the development of mid-range water reducers. These admixtures reduce water content by at least 8 percent and tend to be more stable over a wider range of temperatures. Mid-range water reducers provide more consistent setting times than standard water reducers.

Retarding admixtures, which slow the setting rate of concrete, are used to counteract the accelerating effect of hot weather on concrete setting. High temperatures often cause an increased rate of hardening which makes placing and finishing difficult. Retarders keep concrete workable during placement and delay the initial set of concrete. Most retarders also function as water reducers and may entrain some air in concrete. Accelerating admixtures increase the rate of early strength development, reduce the time required for proper curing and protection, and speed up the start of finishing operations. Accelerating admixtures are especially useful for modifying the properties of concrete in cold weather. Superplasticizers, also known as plasticizers or high-range water reducers (HRWR), reduce water content by 12 to 30 percent and can be added to concrete with a low-to-normal slump and water-cement ratio to make high-slump flowing concrete. Flowing concrete is a highly fluid but workable concrete that can be placed with little or no vibration or compaction. The effect of superplasticizers lasts only 30 to 60 minutes, depending on the brand and dosage rate, and is followed by a rapid loss in workability. As a result of the slump loss, superplasticizers are usually added to concrete at the jobsite. Corrosion-inhibiting admixtures fall into the specialty admixture category and are used to slow corrosion of reinforcing steel in concrete. Corrosion inhibitors can be used as a defensive strategy for concrete structures, such as marine facilities, highway bridges, and parking garages, that will be exposed to high concentrations of chloride. Other specialty admixtures include shrinkage-reducing admixtures and alkali-silica reactivity inhibitors. The shrinkage reducers are used to control drying shrinkage and minimize cracking, while ASR inhibitors control durability problems associated with alkali-silica reactivity.

In the manufacture of concrete masonry elements ts it is customary to use a binding agent and aggregates. The binding agent is often a paste consisting of Portland cement and water. The aggregates generally consist of either natural sands and gravel or rock which has been crushed to the desired size and grading.

The properties of both freshly mixed and hardened concrete depend upon the manner in which these materials are proportioned, mixed and the manner in which the concrete is subsequently placed, finished and cured. The quality and the performance of the concrete is influenced by the properties of the constituent materials and especially the cement

In the hydration of portland cement, the tricalcium aluminate, begins to react instantly upon addition of water to the cement. The sulphate and hydroxyl ions activate the subsequent hydration of the calcium silicates. Sulphate ions are available from the added gypsum during manufacture of Portland cement. The hydration reaction liberates a large amount of lime, calcium hydroxide, Ca(OH)2, referred to as portlandite.

In normal use the portlandite either remains within the hydrating/hydrated matrix or is leached by moisture movement to the surface where water evaporates and the remaining solid material is carbonated to form efflorescence. The voids caused by the lime leaching out does not contribute to strength nor to durability.

Lightweight aggregates have been used in cementitious mixes in the past such as that described in U.S. Pat. No. 5,624,491 which discloses concrete and mortar containing fly ash, and other hardenable mixtures comprising cement and fly ash for use in construction. The invention disclosed includes a method for predicting the compressive strength of such a hardenable mixture, which is very important for planning a project. The patent also discloses hardenable mixtures comprising cement and fly ash which can achieve greater compressive strength than hardenable mixtures containing only concrete over the time period relevant for construction. In a specific embodiment, a formula is provided that accurately predicts compressive strength of concrete containing fly ash out to 180 days. In other specific examples, concrete and mortar containing about 15% to 25% fly ash as a replacement for cement, which are capable of meeting design specifications required for building and highway construction, are provided.

In another example, U.S. Pat. No. 6,869,473 discloses cementitious materials including stainless steel slag and geopolymer which can be added to conventional cement compositions, such as Portland cement, as a partial or total replacement for conventional cement materials. The stainless steel slag may comprise silicates and/or oxides of calcium, silicon, magnesium, iron, aluminium, manganese, titanium, sulfur, chromium and/or nickel. The geopolymer may comprise aluminium silicate and/or magnesium silicate.

Portland cements are hydraulic cements that chemically react and harden with the addition of water. Portland cement contains limestone, clay, cement rock and iron ore blended and heated to a temperature of about 2600-3000.degrees. F. The resulting product is subsequently ground to a powder consistency and mixed with gypsum to control setting time. Portland cement is used in many architectural, masonry and construction applications, most notably as concrete for roads, runways, slabs, floors, walls, precast structures and the like.

Much experimentation has taken place with respect to cement based concretes in an attempt to reduce or eliminate the dependency on the availability of limestone, clay, cement rock and iron ore. For example, U.S. Pat. No. 5,820,668 discloses inorganic binder compositions that may be used as partial substitutes or total replacements for Portland cement for such applications. The inorganic binder compositions include materials such as fly ash, Al.sub.2 O.sub.3, pozzolan, nephelene, syenite, aluminium silicate, sodium hydroxide, silicic acid, potassium salt and sodium salt.

Manufacturers are constantly experimenting with cement based to improve fatigue resistance stresses, thermal ratings, acid rain resistance and durability. With the growing popularity of cement-alternative compositions and the desire to re-use manufacturing by-products such as stainless steel slag, a cementitious material that incorporates a manufacturing by-product material and exhibits improved properties is highly desirable.

The prior art teaches cost effective environmentally friendly cementitious materials and products thereof that incorporate stainless steel slag and exhibit improved durability, acid resistance. It is also known that the compressive strength of portland cement concrete may be increased by incorporating up to about 10% of reactive, amorphous silica in the concrete mixture which reacts with calcium hydroxide produced by the hydration of portland cement. The reaction of the calcium hydroxide and silica produces additional calcium silicate hydrate gel that bonds the aggregate particles in the concrete together.

U.S. Pat. No. 4,997,484 discloses a process in which fly ash, an alkali activator such as sodium hydroxide, and citric acid are incorporated to produce a cement that achieves high strength in a short curing time.

U.S. Pat. No. 4,306,912 discloses a process in which a short hardening time and early attainment of high strength are achieved by addition to the cement mixture of a sulfonated polyelectrolyte and sodium carbonate and/or sodium hydroxide.

U.S. Pat. No. 4,509,985 describes a process whereby early high strength is achieved by adding ground blast furnace slag to a mixture of aluminosilicate oxide, an alkali metal hydroxide, and an alkali metal polysilicate.

U.S. Pat. No. 5,531,824 discloses a method of increasing density and strength of highly siliceous cement-based materials by blending portland cement, water, and aggregate with a source of reactive silica, pouring the concrete mixture into a form, allowing the concrete to cure until it reaches its conventional 28-day strength, and immersing the cured concrete in a solution of alkali metal hydroxide and aluminium nitrate at 60.degree.-110.degree. C. for 3-14 days. Compressive strength and surface hardness of the concrete is increased, and the water infiltration rate into the concrete is decreased. It is know to provide a process whereby the hardness and compressive strength of concrete and other cement-based products such as mortar or grout are increased by allowing a hard, impervious, alkali metal aluminium silicate layer to form in the pores of specially formulated concrete. A source of reactive silica, such as fly ash, finely-ground blast furnace slag, metakaolin, or other glassy silicates, is provided in the concrete and later made to react with concentrated sodium or potassium hydroxide and a source of aluminium at elevated temperature. A recrystallisation process fills the pores of the concrete and forms a hard, impervious surface layer in the presence of the hydrated cement and aggregate, which increases the compressive strength of the concrete.

It may be seen from the above examples that substantial experimentation has in the past been conducted on cement based mixes all directed to improving certain properties of the matrix.

Although blast furnace slag has been used in concrete matrices in the past, it has not hitherto been known to provide moulded brick and masonry products consisting mainly of granulated iron blast furnace slag as an aggregate.

Bottom ash has been used to manufacture masonry units. Bricks or other construction elements have not previously been manufactured from large proportions of bottom ash. Granulated iron blast furnace slag with high iron contents, air-cooled blast furnace slag and mixtures of both have been used in the past in small quantities in the manufacture of masonry units to enhance their fire rating and reduce production costs.

However, granulated iron blast furnace slags have not been used primarily as cementitious aggregates to produce bricks or masonry units. Granulated iron blast furnace slags have been used as fillers with low range percentage.

Invention

The present invention has been developed in view of the foregoing to improve certain properties of masonry cement based elements and to provide a useful alternative to the known masonry elements. The invention has also been developed to recycle and use a plentiful resource—iron blast furnace slag—which would otherwise be underutilised or simply a waste product.

The present invention provides brick and masonry elements manufactured from lightweight aggregate materials and further provides methods of manufacture of such masonry elements such as bricks and construction blocks and to a cementitious matrix for manufacture of such elements which includes granulated iron blast furnace slag as an aggregate and at least a hydraulic cement.

The production of moulded brick and masonry products consisting mainly of granulated iron blast furnace slag as an aggregate was not to the best of the applicant's knowledge known before the present invention. The moulded brick and masonry products to be described herein may according to one embodiment, consist of up to 80% of granulated iron blast furnace slag, 10% ground granulated iron blast furnace slag and 10% Portland cement or other hydraulic binder.

The matrix composition to be described herein produces moulded brick and masonry products that have a reduction in mass and bulk density and maintain a required structural integrity. The products also have the property due to the use granulated iron blast furnace slag of reduced sound transmission, increased fire resistance, improved chemical durability especially in selenitic soils and environments and can be nailed, screwed and cut without use of specialised tools.

In one broad form the present invention comprises:

a moulded masonry product formed from a group of materials including;

an aggregate comprising granulated iron blast furnace slag;

air-cooled iron blast furnace slag,

bottom ash,

pulverised fuel ash and a cementitious binder consisting of portland cement; and

ground granulated iron blast furnace slag.

In another broad form the present invention comprises:

a dry cementitious matrix for forming a masonry product, the matrix formed from a group of materials including;

an aggregate comprising granulated iron blast furnace slag;

air-cooled iron blast furnace slag,

bottom ash,

pulverised fuel ash and a cementitious binder consisting of portland cement; and

ground granulated iron blast furnace slag.

In another broad form the present invention comprises:

a cementitious matrix for forming a masonry product, the matrix formed from a group of materials including;

an aggregate comprising granulated iron blast furnace slag;

air-cooled iron blast furnace slag,

bottom ash,

pulverised fuel ash and a cementitious binder consisting of portland cement; and

ground granulated iron blast furnace slag; and

water.

Preferably the granulated iron blast furnace slag is used as a lightweight aggregate as well as a latent cementitious material.

The ground granulated iron blast furnace slag is preferably used as a supplementary cementitious material utilising portlandite (calcium hydroxide) generated by hydrating Portland cement to form calcium silicate/aluminate hydrates similar to those found in hydrated Portland cement.

In another broad form the present invention comprises:

a cementitious matrix for forming discrete construction elements, the matrix including ingredients comprising:

at least one aggregate,

at least one binder

at least one admixture; and

water;

characterised in that the aggregate is selected from one or more of:
(i) granulated iron blast furnace slag,
(ii) air-cooled iron blast furnace slag,
(iii) bottom ash;
(iv) fly ash.

According to one embodiment the furnace ash may be obtained from boilers of power generating plants. Preferably the fly ash is pulverised fly ash from precipitators and bag-house filters of power generating plant.

According to one non limiting embodiment the binders are selected from one or more of;
(i) ordinary portland cement
(ii) ground granulated iron blast furnace slag.
(iii) fly ash.

According to one non limiting embodiment the admixtures are selected from one or more of:
(i) water reducing agents
(ii) air-entraining agents
(iii) water repelling agents
(iv) set accelerating agents
(v) viscosity modifying agents

Mixing Water may be selected from conventional sources but may include
(i) rain water from factory roofs.
(ii) plant washing water.
(iii) product storage & dispatch area drain water.

The moulded brick and masonry products have a lightweight bulk density inherent from the nature of the granulated iron blast furnace slag used as an aggregate.

In its broadest form the present invention comprises:

a cementitious matrix for forming discrete construction elements, the matrix including

an aggregate which is selected from one or more of:
i) granulated iron blast furnace slag,
ii) air-cooled iron blast furnace slag,
iii) bottom ash;
vi) fly ash; and

water.

In another broad form the present invention comprises:

a masonry product including

an aggregate which is selected from one or more of:
i) granulated iron blast furnace slag,
ii) air-cooled iron blast furnace slag,
iii) bottom ash;
iv) fly ash.

In another broad form the present invention comprises:

a building element for use in a structure, the element including

an aggregate which is selected from one or more of:
i) granulated iron blast furnace slag,
ii) air-cooled iron blast furnace slag,
iii) bottom ash;
iv) fly ash.

According to a method aspect the present invention comprises:

a method of manufacture of a product from a cementitious matrix, the method comprising the steps of;

a) blending in any order a dry mix composition comprising;
i) at least one aggregate selected from one or more of:
   granulated iron blast furnace slag,
   air-cooled iron blast furnace slag,
   bottom ash;
   fly ash.
ii) at least one binder
iii) at least one admixture; and

b) adding additives.

The method comprises the further steps of;
a) adding water
b) mixing the composition; and
c) allowing the mix to set for a predetermined period of time.

According to the method aspect the present invention comprises:

a method of manufacture of a product from a cementitious matrix, the method comprising the steps of;

a) blending in order of material introduction a dry mix composition of raw materials according to weight and proportion comprising;
i) at least one aggregate selected from one or more of:
   granulated iron blast furnace slag,
   air-cooled iron blast furnace slag,
   bottom ash;
   fly ash.
ii) at least one binder
iii) at least one admixture
iv) vibrating the dry mix; and
v) adding water to initiate hydration;
vi) placing the mix composition in a mould
vii) allowing the composition to set for a predetermined time; and
viii) releasing the composition from the mould.

To ensure that the chemical reactions between the portlandite, granulated slag and ground granulated iron blast furnace slag proceed rapidly, the moulded brick and masonry products are cured for a specified period at 65 degrees Celsius and 95% Relative Humidity.

### BRIEF DESCRIPTION OF DRAWINGS

The present invention will be described in more detail according to a preferred but non limiting embodiment and with reference to the accompanying illustrations wherein:

FIG. 1 shows a table of Granulated Iron Blast Furnace Slag—Particle Size Distribution

FIG. 2 shows composition parameters and particularly maximum and minimum of Granulated Iron Blast Furnace Slag values for Elemental Chemistry, Percent by Mass

FIG. 3 shows particle size distribution for Air-cooled Blast Furnace Slag.

FIG. 4 shows chemical composition of Air-cooled Blast Furnace Slag.

FIG. 5 shows the chemical properties of Ground Granulated Iron Blast Furnace Slag Properties.

FIG. 6 shows typical compositions in accordance with the invention according to % dry basis by mass

FIG. 7 shows a grading or particle size distribution graph.

FIG. 8 These curing conditions are maintained at specific profiles in each curing chamber

### DETAILED DESCRIPTION

The present invention will be described below with reference to example compositions but it will be appreciated by persons skilled in the art that the examples are non limiting.

As will be apparent from the description, there are numerous permutations and combinations of the invention embodied herein. Characterising each embodiment of the invention is the use of granulated iron blast furnace slag as a primary aggregate.

A matrix composition will typically comprise at least one aggregate, at least one binder, and at least one admixture which is combined with mixing water, wherein one of the aggregates will comprise granulated iron blast furnace slag.

According to an alternative embodiment, in addition to the constituents of the aforesaid composition, additional or alternative aggregates used may comprise air-cooled iron blast furnace slag, bottom ash ( furnace ash from boilers of power generating plant), fly ash (pulverised fly ash from electrostatic precipitators and bag-house filters of power generating plant).

Binders for the composition will according to one embodiment be selected from portland cement, ground granulated iron blast furnace slag or fly ash. Typically concrete mixes include various admixtures depending upon the characteristics required for the products of the compositions. Admixtures include water reducing agents, air-entraining agents or water repelling agents. The above described composition is a dry mix matrix. When water is added hydration takes place in the usual manner.

Mixing water will be obtained from conventional water sources such as rain water from factory roofs, plant washing water or product storage & dispatch area drain water.

As indicated previously, the hydration reaction liberates a large amount of lime, calcium hydroxide, Ca(OH)2, referred to as portlandite. The addition of hydraulically active materials such as granulated blast furnace slag can be used to convert lime into additional cementing agents. The use of ground granulated iron blast furnace slag is an alternative to Portland cement. The use of coarse graded granulated blast furnace slag results in a reactive aggregate producing a hydration product between the surface of the slag particle and the portlandite.

This reaction results in formation of a cementitious product bonding aggregate particles together as well as formation of a superior bond between the matrix and the aggregates present. The hydration of slag largely depends upon the breakdown and dissolution of the glassy slag structure by hydroxyl ions released during the hydration of the portland cement. The hydration of the slag, therefore, proceeds and continues to consume calcium hydroxide and uses it for additional hydrated calcium silicate and hydrated calcium silicate/aluminate formation.

X-ray diffraction patterns indicate that ettringite is the predominant hydration product at early ages. The amount of portlandite produced by cement hydration appears to reach a maximum at about 7 days. The diffraction patterns of mature slag/cement paste shows the presence of mainly calcium silicate hydrate, calcium aluminate hydrate and calcium hydroxide

Slag cements are therefore able to accommodate alkalies in the cement paste more effectively than Portland cement. It has been shown that alkali-hydroxide alone, that is, without calcium hydroxide from Portland cement hydration, can hydrate slag to form a strong cement paste structure.

The morphology of the slag hydrates is found to be more gel-like than the products of hydration of portland cement and so adds denseness to the cement paste.

To ensure that the slag develops its maximum hydraulic properties, it is necessary to rapidly chill the molten slag as it leaves the blast furnace. Rapid “quenching” or chilling prevents crystallization and converts the molten slag into sand-sized particles of predominantly amorphous or non-crystalline glass, referred to as granulated slag. It is generally recognized that the cementitious action of a slag is dependent to a large extent on the glass content, although other factors will also have some influence. The vesicular nature of granulated slag provides a large surface area for hydraulic reaction as well as reducing the particle density. Slowly cooled slags are predominantly crystalline and do not possess significant cementitious properties.

For fly ashes, the reaction is one of a pozzolanic nature. The amorphous phases of the fly ash reacting with calcium hydroxide to form silicate hydrates. This process requires the constant presence of lime/water and is time dependent. The reaction of coarse fly ash particle are not as reactive as slag but do have a lower particle density and contribute to lowering of the mass of manufactured products.

The temperature and relative humidity at which the concrete is cured will have a great effect on the strength of the concrete, particularly at early ages.

Concrete containing slag and/or fly ash is found to respond very well under elevated temperature curing conditions. In fact, strengths exceeding those of portland cement concrete at 1 day and can be achieved.

Conversely, strength reductions at early ages are expected with concrete containing slag and fly ash, cured at low temperatures.

Of particular interest is the flexural strength (modulus of rupture). When slag and fly ash are used at optimum proportions, these blended cements generally yield higher moduli of rupture at ages beyond 7 days, than do plain concretes. This is believed to be a result of the increased denseness of the paste in the concrete.

Regardless of the cement or the blends of cementitious materials used, concrete must be kept in a proper moisture and temperature condition if it is to fully develop its strength and durability potential.

There is no doubt that rate and degree of hydration can be affected by the loss of moisture with a subsequent loss of strength. This characteristic varies depending on the maturity of the paste at which time the concrete dries.

For uncracked concrete, the ease of ingress of deleterious substances into concrete depends mainly on the permeability of the cement paste which in turn depends on pore size distribution, structure and total porosity. In general, the influence of large pores and the continuity of the pore system are the important factors.

The pore structure of cement pastes containing fly ash and slag are somewhat different from that of plain cement paste.

In slag cement pastes, although the total porosity is about the same as that of plain cement paste, there is a significant decrease in the coarser pore size range. The difference in pore structure development has been attributed to the differences between the hydration processes in blended and plain cements.

The finer pore size distribution in the blended cement pastes are reported to be caused by capillary blockage and pore filling with calcium silicate hydrate precipitates and the decreased presence of calcium hydroxide from portland cement hydration.

The pozzolanic reaction that occurs in fly ash cement pastes produces calcium silicate hydrates which fill available pore space.

Early studies of fly ash concretes showed that at 28 days portland cement concrete was less permeable than fly ash concrete. This was due to the combined effects of less reacted material in the fly ash paste and an initial low pozzolanic activity. After six months, this trend was reversed and the fly ash concretes became less permeable. By this time, the pozzolanic reaction had changed the structure of the pore-void system, reducing its permeability.

The permeability of fly ash cements is sensitive to curing conditions. Unless proper curing conditions are applied, insitu permeability may be higher than expected.

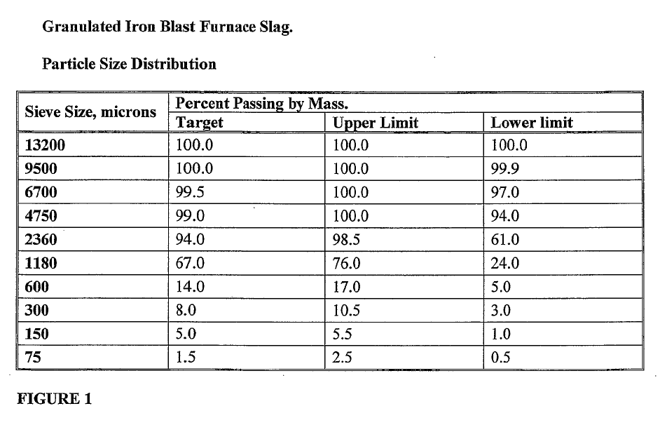

Referring to FIG. 1 there is shown a table of Granulated Iron Blast Furnace Slag setting out Particle Size Distribution.

From the table of FIG. 1 it may be seen from the target, upper limit and lower limit parameters that as sieve size decreases, the percentage of Granulated Iron Blast Furnace Slag passing through by mass decreases.

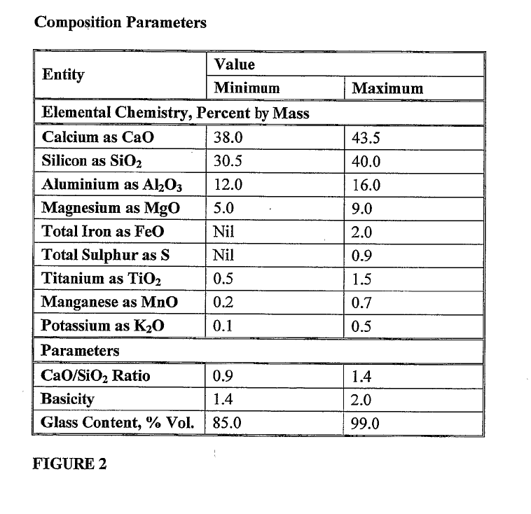

FIG. 2 shows composition parameters and particularly maximum and minimum percentage mass values of Granulated Iron Blast Furnace Slag values for its Elemental Chemistry. The Bulk Density of Loose Granulated Iron Blast Furnace Slag is preferably less than 1.2 tonnes per m³

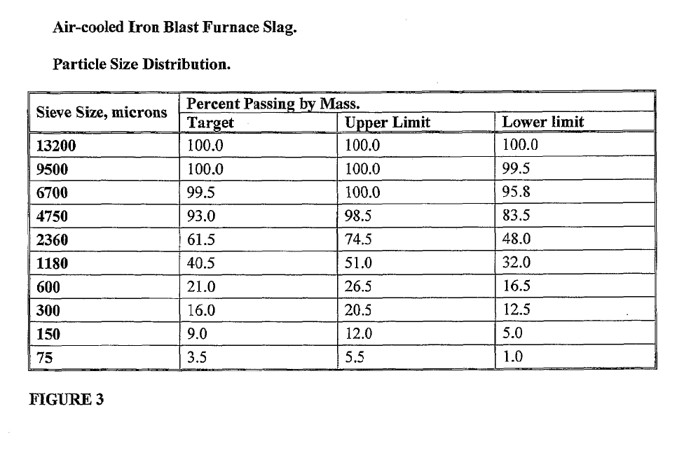

FIG. 3 shows particle size distribution for air cooled Blast Furnace Slag.

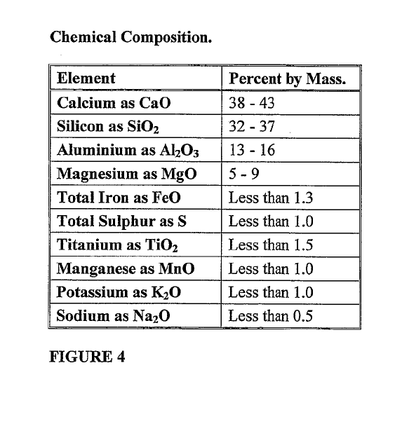

FIG. 4 shows chemical composition of air cooled Blast Furnace Slag. The table shows sieve size in microns and % passing through the sieve by mass. The table indicates an optimal (target) value along with the upper and lower limits.

The Bulk Density of Loose air cooled Blast Furnace Slag is 1.35-1.45 tonnes per m^{3.} Where compacted the bulk density is 1.50-1.60 tonnes per m³

Particle Density

| | |
|---|---|
| Dry | 2.70-2.80 tonnes per m³ |
| SSD | 2.75-2.85 tonnes per m³ |

(i) Bottom Ash.
Bottom ash requirement is for material passing 10 mm screen.
Selection based on lowest bulk density and lowest carbon content available.
(ii) Fly Ash.
Run-of-station fly ash is used.
Selection based on lowest bulk density and lowest carbon content available.

Binders.
(i) Portland cement.
(ii) Ground granulated iron blast furnace slag.
(iii) Fly ash.

Commercially available binders and supplementary materials are used.

These materials comply with relevant specifications pertinent to the construction industry.

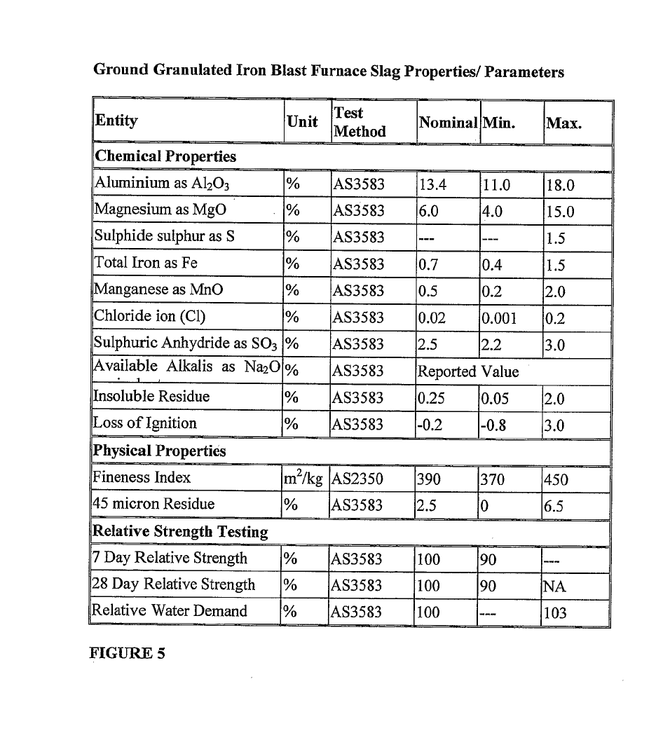

FIG. 5 shows the chemical properties of Ground Granulated Iron Blast Furnace Slag. Ground granulated iron blast furnace slag must have the parameters as shown in the table of FIG. 5.

Further parameters included in a composition manufactured in accordance with the invention are:

Admixtures.
(i) Water reducing agents.
(ii) Air-entraining agents.
(iii) Water repelling agents.
(iv) Set accelerating agents
(v) Viscosity modifying agents

Commercially available binders and supplementary materials are used.

These materials comply with relevant specifications pertinent to the construction industry.

Mixing Water.
(i) Rain water from factory roofs.
(ii) Plant washing water.
(iii) Product storage & dispatch area drain water.

Water containing alkali salts such as calcium, sodium and potassium is preferred since these elements, in solution, nucleate and promote hydration of the slag materials.

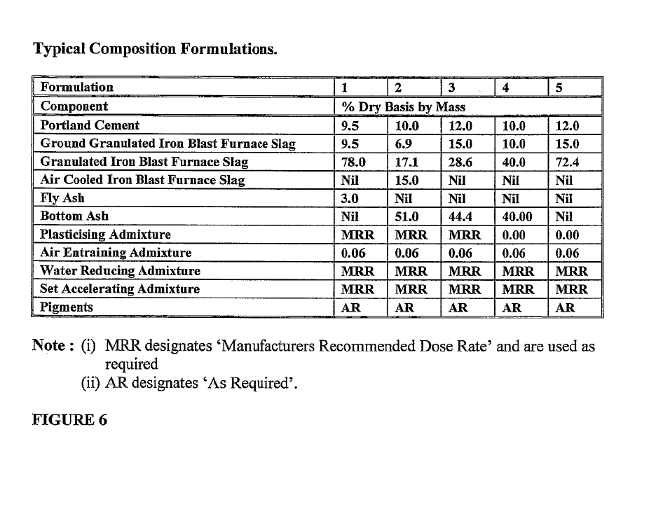

FIG. 6 shows typical composition/formulations in accordance with the invention according to % dry basis by mass. It can be seen from this table that the majority of the formulation in each composition is granulated blast furnace slag. In each case the constituent with the highest percentage is granulated Iron Blast Furnace Slag

Inventive Formulations.
(i) The proportioning of the materials for manufacture of bricks and masonry units is by “Particle Packing Principles” using a modified form of the Dinger-Funk Formula.
   The modified Dinger-Funk Formula

VP_{SIZE}=100*((Sieve Size, microns)e^{q}−(Minimum Particle Size, microns)e^{q})/((Maximum Particle Size, microns)e^{q}−(Minimum Particle Size, microns)e^{q})
‘q’ determines the fineness of the distribution and is usually set at 0.3

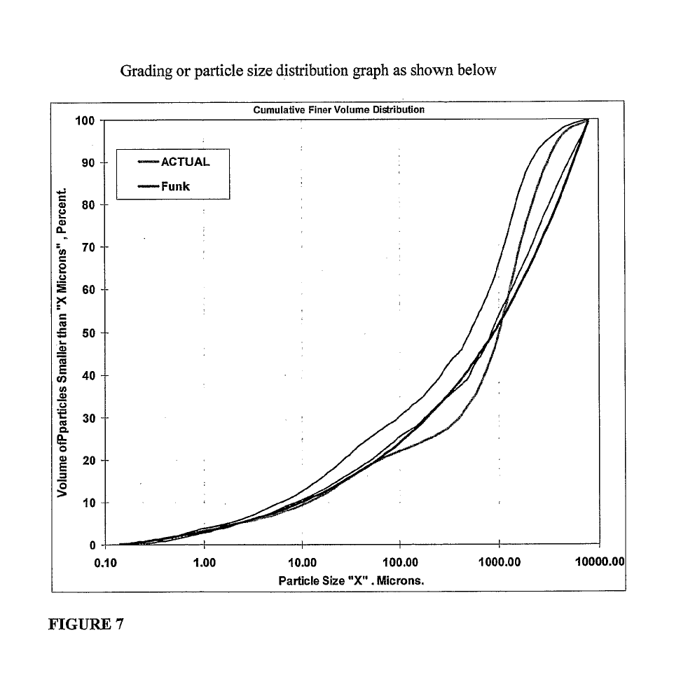

This is used to construct a grading or particle size distribution graph as shown in FIG. 7

FIG. 7 shows a grading or particle size distribution graph.

The materials to be used are proportioned to fit the Dinger-Funk Distribution Function. Upper and Lower Limits can be set for production purposes to allow some control variability.

The curing conditions are maintained at specific profiles in each curing chamber.

For the hydration reaction of supplementary cementitious materials to proceed, alkali entities such as sodium, potassium and calcium hydroxides in presence of interstitial humidity greater than 85% are required.

Portland cement hydration liberates the required calcium hydroxide which is then available for reaction with the slag components of the matrix mix. Steam curing is used to provide the necessary relative humidity at a temperature of 65 degrees Celsius.

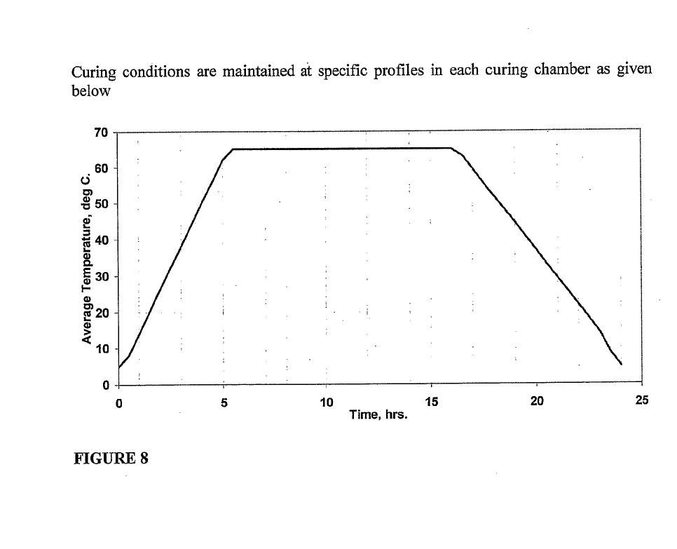

These curing conditions are maintained at specific profiles in each curing chamber as shown in the graph of FIG. 8

As shown in FIG. 8, the curing regime ensures sufficient reaction occurs to provide a compressive strength equivalent to 4 days of normal curing.

Environmental Benefits.

Due to the fact that the bulk of materials utilised are industrial co-products or by-products, the greenhouse gas emissions have already been taken up in the manufactured product; iron in the case of slag and electricity in the case of fly ash.

The contributions to greenhouse gas emissions calculated on manufactured bricks are:

| | |
|---|---|
| Slag/Ash Bricks | 0.02186 tonnes CO₂ per m² of wall. |
| Clay Bricks | 0.03394 tonnes CO₂ per m² of wall. |
| Concrete Bricks | 0.03765 tonnes CO₂ per m² of wall. |

Other Binders.

The Blast furnace slags used as aggregate and as binder can be activated with a number of different chemicals such as:

Caustic Soda

Hydrated Lime

Sodium Silicate

Sodium Carbonate

Various combinations of the above

The advantages of the compositions and products manufactured in accordance with the invention are numerous. Ground iron blast furnace slag could be used as an extender. Products can be up to and more than 50% lighter than a similar sized product using a conventional aggregate. The products are slow to set which ensures complete hydration and they are ideal for underwater uses. The compositions may be used in construction elements such as but not limited to blocks, slabs, bricks, precast panels, and rendered walls. In the case of the latter, the render chemically reacts with the ground iron blast furnace slag aggregates and increases bonding strength chemically as well as mechanically. The compositions may also be used in construction of brick veneer walls and may be screwed or sawed. The products may be adjusted so that properties are achieved for particular applications such as sound proofing. For instance, the blocks may be made non porous, low or high density. Slag aggregate size will be preferably within the non limiting range of 7-10 mm. The products will typically be manufactured from a mould according to conventional methodology. The raw slag will undergo pre preparations before introduction into the dry matrix prior to mixing. The invention may be applied in the manufacture of conventional standard sized masonry products with increased durability and high strength to weight ratio. The properties described herein and achieved by producing elements having the matrix according to embodiments of the invention are not known in the art. Despite the use of the granulated iron blast furnace slag as aggregate, the products do not suffer from unwanted shrinkage and in fact the use of that aggregate significantly reduces shrinkage compared to a product manufactured in accordance with the prior art methods and constituents.

The products are, when manufactured using granulated iron blast furnace slag, more able to withstand acid rain, are more stable, will resist degradation from chemical ground interaction are les prone to efflorescence as slag absorbs any alkalinity in the matrix.

The products will have good thermal and acoustic properties. Porosity and permeability will be largely determined by how lightweight the product is. Ground iron blast furnace slag used as an aggregate forms the skeleton which also forms the ‘glue’ which bonds the matrix together. The slag particles are activated to bind themselves.

It will be recognised by persons skilled in the art that numerous variations and modifications may be made to the invention as broadly described herein without departing from the overall spirit and scope of the invention.

The claims defining the invention are as follows:

1. A cementitious matrix used in the formation of masonry products the matrix including;
at least one aggregate selected from one or more of:
air-cooled iron blast furnace slag,
bottom ash,
pulverised fuel ash and; and
ground granulated iron blast furnace slag.

2. A cementitious matrix according to claim 1 further comprising:
at least one binder.

3. A matrix according to claim 2 further comprising water and a cementitious binder comprising portland cement.

4. A matrix according to claim 3 wherein at least one admixture.

5. A matrix according to claim 4 wherein the at least one admixture is selected from one or more of the following:
i) water reducing agents.
ii) air-entraining agents.
iii) water repelling agents.
iv) set accelerating agents
v) viscosity modifying agents

6. A matrix according to claim 5 wherein the at least one binder is selected from one or more of:
i) ordinary portland cement
ii) ground granulated iron blast furnace slag.
iii) fly ash.

7. A matrix according to claim 6 wherein the blast furnace slag used as an aggregate and as a binder is activated to act as a binder by one or more of the following chemicals:
Caustic Soda
Hydrated Lime
Sodium Silicate
Sodium Carbonate
Various combinations of the above

8. A matrix according to claim 7 wherein the composition is introduced into a mould for manufacture of a masonry building block.

9. A masonry block according to claim 8 where when Portland cement is in the matrix hydration liberates the required calcium hydroxide which is then available for reaction with the slag components of the matrix mix.

10. A matrix according to claim 9 wherein, the bulk density of the granulated iron blast furnace slag is preferably less than 1.2 tonnes per m³.

11. A matrix according to claim 10 wherein the bulk density of the air cooled blast furnace slag is 1.35-1.45 tonnes per m³.

12. A matrix according to claim 11 wherein the bulk density of the air cooled blast furnace slag when compacted is 1.50-1.60 tonnes per m³.

13. A matrix according to claim 11 wherein said masonry products produced from said matrix are at least 30% and up to 50% lighter than a similar sized masonry product using a conventional aggregate.

14. A matrix according to claim 13 wherein, the products manufactured from the matrix comprise include blocks, slabs, bricks, precast panels, and rendered walls.

15. A cementitious matrix used in forming a masonry product, the matrix comprising;
granulated iron blast furnace slag as an aggregate;
air-cooled iron blast furnace slag,
bottom ash,
pulverised fuel ash and a cementitious binder; and
ground granulated iron blast furnace slag; and
water.

16. A matrix according to claim 15 wherein, the cementitious binder is selected from one or more of Portland cement, ground granulated iron blast furnace slag or fly ash.

17. A cementitious matrix for forming a moulded masonry product, the matrix comprising;
at least one binder;
an aggregate selected from one or more of:
i) granulated iron blast furnace slag,
ii) air-cooled iron blast furnace slag,
iii) bottom ash;
iv) fly ash.
vi) pulverised fuel ash and at least one cementitious binder; and
v) ground granulated iron blast furnace slag; and water.

18. A matrix according to claim 17 wherein, the at least one binder is selected from one or more of;
i) ordinary portland cement
ii) ground granulated iron blast furnace slag.
iii) fly ash.

19. A matrix according to claim 18 wherein, said ground granulated iron blast furnace slag also acts as a latent supplementary cementitious binder.

20. A matrix according to claim 19 wherein, the cementitious binder includes Portland cement.

21. A matrix according to claim 20 wherein the ground granulated iron blast furnace slag combines with calcium hydroxides generated by said Portland cement.

22. A matrix according to claim 21 wherein, the ground granulated iron blast furnace slag and calcium hydroxides aluminate combine/react to form calcium silicate/aluminate hydrates.

23. A matrix according to claim 22 wherein, granulated blast furnace slag when used as aggregate and as said binder is activated with chemicals selected from:
Caustic Soda
Hydrated Lime
Sodium Silicate
Sodium Carbonate
Various combinations of the above

24. A matrix according to claim 23 further comprising at least one admixture.

25. A matrix according to claim 24 wherein the at least one admixture is selected from one or more of the following:
i) water reducing agents
ii) air-entraining agents
iii) water repelling agents
iv) set accelerating agents
v) viscosity modifying agents

26. A cementitious matrix for use in manufacturing construction elements in a mould, the matrix comprising:
at least one aggregate,
at least one binder
at least one admixture; and
water;
characterised in that the aggregate is selected from one or more of:
i) granulated iron blast furnace slag,
ii) air-cooled iron blast furnace slag,
iii) bottom ash;
iv) fly ash.

27. A matrix according to claim 26 wherein the at least one binder is selected from one or more of;
i) ordinary portland cement
ii) ground granulated iron blast furnace slag.
iii) fly ash.

28. A matrix according to claim 27 wherein the admixtures are selected from one or more of:
i) water reducing agents
ii) air-entraining agents
iii) water repelling agents
iv) set accelerating agents
v) viscosity modifying agents

29. A matrix according to claim 28 wherein the proportion of granulated iron blast furnace slag used as an aggregate influences the lightweight bulk density of the masonry products.

30. A masonry block manufactured from a cementitious matrix composition including:
an aggregate which is selected from one or more of:
i) granulated iron blast furnace slag,
ii) air-cooled iron blast furnace slag,
iii) bottom ash;
iv) fly ash.
v) ground granulated iron blast furnace slag.
vi) pulverised fuel ash;
water; and
at least one binder.

31. A masonry block according to claim 30 wherein, the cementitious matrix further comprises:, at least one admixture.

32. A masonry block according to claim 31 wherein at least one admixture is selected from on or more of the following:
i) water reducing agents.
ii) air-entraining agents.
iii) water repelling agents.
iv) set accelerating agents
v) viscosity modifying agents

33. A masonry block according to claim 32 wherein the binder is selected from one or more of Portland cement, ground granulated iron blast furnace slag or fly ash.

34. A masonry block according to claim 33 wherein the composition is introduced into a mould of a predetermined shape for forming the block.

35. A cementitious matrix for forming a moulded masonry product, the matrix formed from a group of materials comprising;
an aggregate comprising granulated iron blast furnace slag;
air-cooled iron blast furnace slag,
bottom ash,
pulverised fuel ash and at least one cementitious binder; and
ground granulated iron blast furnace slag acting as binder and aggregate; and
water.

36. A matrix according to claim 35 wherein, the at least one binder is selected from one or more of;
i) ordinary portland cement
ii) ground granulated iron blast furnace slag.
iii) fly ash.

37. A matrix according to claim 36 wherein, said ground granulated iron blast furnace slag also acts as a latent supplementary cementitious binder.

38. A matrix according to claim 37 wherein, the cementitious binder includes Portland cement.

39. A matrix according to claim 38 wherein the ground granulated iron blast furnace slag combines with calcium hydroxides generated by said Portland cement.

40. A matrix according to claim 39 wherein the ground granulated iron blast furnace slag and calcium hydroxides aluminate combine/ react to form calcium silicate/aluminate hydrates.

41. A matrix according to claim 40 further comprising at least one admixture selected from one or more of the following:
i) water reducing agents
ii) air-entraining agents
iii) water repelling agents
iv) set accelerating agents
v) viscosity modifying agents

41. A cementitious matrix for use in manufacturing moulded construction elements in the matrix comprising:
at least one aggregate,
at least one binder
at least one admixture; and
water;
characterised in that the aggregate is selected from one or more of:
i) granulated iron blast furnace slag,
ii) air-cooled iron blast furnace slag,
iii) bottom ash;
iv) fly ash.
at least one binder is selected from one or more of;
i) ordinary portland cement
ii) ground granulated iron blast furnace slag.
iii) fly ash.
and an admixtures selected from one or more of:
i) water reducing agents
ii) air-entraining agents
iii) water repelling agents
iv) set accelerating agents
v) viscosity modifying agents

42. A method of manufacture of a moulded masonry product from a cementitious matrix, the method comprising the steps of;
a) blending in any order a dry mix composition comprising;
i) at least one aggregate selected from one or more of:
granulated iron blast furnace slag,
air-cooled iron blast furnace slag,
bottom ash;
fly ash.
ground granulated iron blast furnace slag
ii) at least one binder
iii) at least one admixture; and
water;
mixing the matrix prior to introducing the matrix into a mould and allowing the matrix to set for a predetermined period of time.

43. A method according to claim 42 comprising the further steps of
a) blending in order of material introduction a dry mix composition of raw materials according to weight and proportion comprising;
i) at least one aggregate selected from one or more of:
granulated iron blast furnace slag,
air-cooled iron blast furnace slag,
bottom ash;
fly ash.
ii) at least one binder
iii) at least one admixture
iv) vibrating the dry mix; and
v) adding water to initiate hydration;
vi) placing the mix composition in a mould
vii) allowing the composition to set for a predetermined time; and
viii) releasing the composition from the mould.

44. A matrix according to claim wherein a hydration reaction in the matrix on mixing liberates lime, calcium hydroxide, Ca(OH)2, (portlandite).

45. A matrix according to claim 44 wherein granulated blast furnace slag converts said lime into additional cementing agents.

46. A matrix according to claim 45 wherein the coarse graded granulated blast furnace slag results in a reactive aggregate producing a hydration product between a surface of the slag particle and the portlandite.
